(19) United States
(12) Patent Application Publication
(10) Pub. No.: US 2026/0211661 A1
(43) Pub. Date: Jul. 23, 2026

(54) CONTROL DEVICE AND CONTROL METHOD FOR A CONTROL DEVICE

(71) Applicant: Toshiba Tec Kabushiki Kaisha, Tokyo (JP)

(72) Inventor: Naoya SATO, Izunokuni Shizuoka (JP)

(21) Appl. No.: 19/358,728

(22) Filed: Oct. 15, 2025

(30) Foreign Application Priority Data
Jan. 22, 2025 (JP) 2025-009274

(51) Int. Cl. G06F 8/65; G05B 15/02

(52) U.S. Cl. CPC G06F 8/65; G05B 15/02

(57) ABSTRACT

In accordance with an embodiment, a control device stores control software. The control device detects that no people are present within a predetermined area and executes reboot for updating the control software on the basis of detection that no people are present within the predetermined area.

### CROSS-REFERENCE TO RELATED APPLICATIONS

This application is based upon and claims the benefit of priority from the prior Japanese Patent Application No. 2025-009274, filed on January 22, 2025, the entire contents of which are incorporated herein by reference.

### FIELD

Embodiments described here generally relate to a control device and a control method for a control device.

### BACKGROUND

A control device that has stored control software needs to execute reboot for updating the control software.

When the control device executes the reboot for updating the control software, it is difficult for the control device to execute control based on the control software until the control device completes the update of the control software. If a printer is employed as an example of the control device, it is difficult for the printer to execute print control until the printer completes the update of the control software.

### BRIEF DESCRIPTION OF THE DRAWINGS

FIG. 1 is a block diagram showing a schematic configuration example of a system according to a first embodiment.

FIG. 2 is a block diagram illustrating a mobile POS printer according to the first embodiment.

FIG. 3 is a configuration diagram illustrating the mobile POS printer according to the first embodiment.

FIG. 4 is a diagram illustrating a partition configuration in an eMMC of the mobile POS printer according to the first embodiment.

FIG. 5 is a diagram illustrating a software configuration of control software according to the first embodiment.

FIG. 6 is a view illustrating a uniform of a clerk according to the first embodiment.

FIG. 7 is a view illustrating a rebooting screen, which is displayed on a touch panel of the mobile POS printer according to the first embodiment.

FIG. 8 is a flowchart illustrating an update process of the control software in the mobile POS printer according to the first embodiment.

FIG. 9 is a block diagram showing a schematic configuration example of a system according to a second embodiment.

FIG. 10 is a block diagram showing a schematic configuration example in a store in the system according to the second embodiment.

FIG. 11 is a block diagram illustrating a mobile settlement terminal according to the second embodiment.

FIG. 12 is a configuration diagram illustrating the mobile settlement terminal according to the second embodiment.

FIG. 13 is a diagram illustrating a partition configuration in an eMMC of the mobile settlement terminal according to the second embodiment.

FIG. 14 is a diagram illustrating a software configuration of control software according to the second embodiment.

FIG. 15 is a block diagram illustrating an IoT gateway according to the second embodiment.

FIG. 16 is an external view illustrating the IoT gateway according to the second embodiment.

FIG. 17 is a diagram illustrating URL information of a network camera according to the second embodiment.

FIG. 18 is a view illustrating a uniform of a clerk according to the second embodiment.

FIG. 19 is a view illustrating a rebooting screen, which is displayed on a touch panel of the mobile settlement terminal according to the second embodiment.

FIG. 20 is a flowchart illustrating an update process of the control software in the mobile settlement terminal according to the second embodiment.

FIG. 21 is a flowchart illustrating a process of a customer search API in the IoT gateway according to the second embodiment.

### DETAILED DESCRIPTION

In accordance with an embodiment, a control device includes storage and a processing circuit. The storage stores control software for enabling control on an operation in the device to be executed. The control software includes an operation control program for controlling the operation of the device and a software update program for updating the control software. The processing circuit executes the control on the operation based on the operation control. The processing circuit detects, in a case of updating the control software on a basis of the software update program, whether or not no people are present within a predetermined area where the device is installed. In addition, the processing circuit executes reboot for updating the control software on a basis of detection that no people are present within the predetermined area.

Hereinafter, some embodiments will be described with reference to the drawings. In the drawing, the same reference signs denote the same or similar portions. It should be noted that in each drawing used for the following description of the embodiments, scales of respective parts may be modified as appropriate. Moreover, in each drawing used for the following description of the embodiments, configuration(s) may be omitted for the sake of description.

### First Embodiment

### Configuration Example

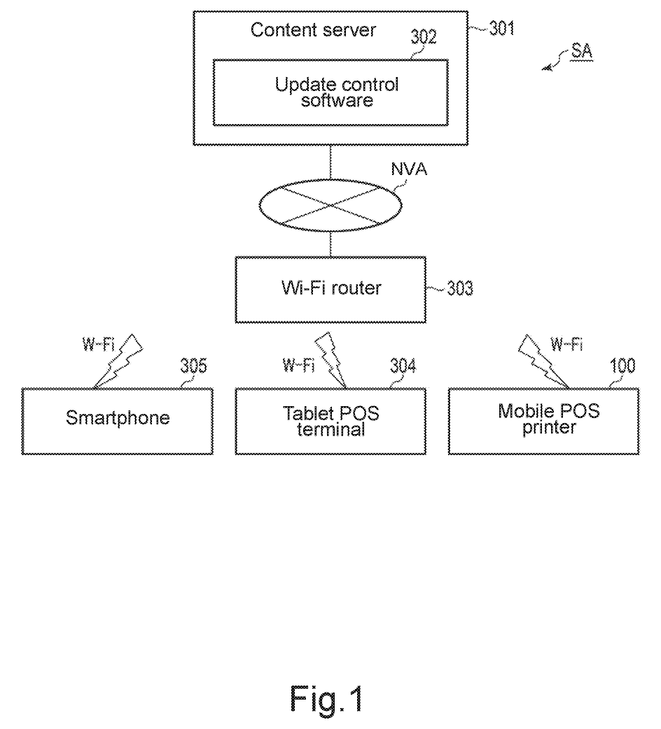

FIG. 1 is a block diagram showing a schematic configuration example of a system SA. The system SA is a system for updating control software in a control device capable of executing control on the basis of the control software. The control may be control on an operation in the control device or may be control on a process in the control device. The control software is software for enabling the control to be executed. The control software is an example of software of the control device.

The system SA includes a mobile point of sales (POS) printer 100, a Wi-Fi router 303, a tablet POS terminal 304, a smartphone 305, and a content server 301. The mobile POS printer 100, the Wi-Fi router 303, and the tablet POS terminal 304 are devices in a store. For example, the store is a mass retailer, such as a supermarket, though not limited thereto. Hereinafter, a customer of the store will be simply referred to as a customer. a clerk of the store will be simply referred to as a clerk. The content server 301 is a device outside the store. The content server 301 may be a cloud server. The system SA is an example of a system including at least two devices of the mobile POS printer 100, the Wi-Fi router 303, the tablet POS terminal 304, the smartphone 305, and the content server 301.

The mobile POS printer 100 is a device capable of issuing a medium on which information regarding transactions at the store has been printed, as a receipt. The transaction is the exchange of money from the customer to the store in connection with sales of goods by the store. The transaction means sales of goods for the store. The transaction means purchase of goods for the customer. The goods may be a product that is a tangible object or may be a service. The mobile POS printer 100 is a device that is used by the clerk. The mobile POS printer 100 is a portable device. The mobile POS printer 100 is a device capable of executing print control as control based on the control software. The mobile POS printer 100 is an example of the control device. The system SA may include one or more mobile POS printers 100.

The Wi-Fi router 303 is a device for connecting another device that performs communication via wireless fidelity (Wi-Fi) to a network virtual appliance (NVA). The system SA may include one or more Wi-Fi routers 303. The Wi-Fi is an example of a wireless local area network (LAN).

The tablet POS terminal 304 is a device capable of displaying the information regarding the transactions at the store. The tablet POS terminal 304 is a device that is used by the clerk. The tablet POS terminal 304 is a portable device. The system SA may include one or more tablet POS terminals 304.

The smartphone 305 is a device with a display function, a communication function, and the like. The smartphone 305 is a device possessed by a person. The smartphone 305 is a portable device. The person is a customer or clerk. In a case where there are one or more people at the store, the system SA can include one or more smartphones 305. In a case where there are no people at the store, the system SA does not include the smartphone 305. The smartphone 305 is an example of a user terminal possessed by the person.

The content server 301 is a device that manages update control software 302, which can be used in the mobile POS printer 100. The update control software 302 is software for switching from the control software before the update to new control software after the update as control software that operates in the mobile POS printer 100. The control software that operates in the mobile POS printer 100 is control software used in the mobile POS printer 100.

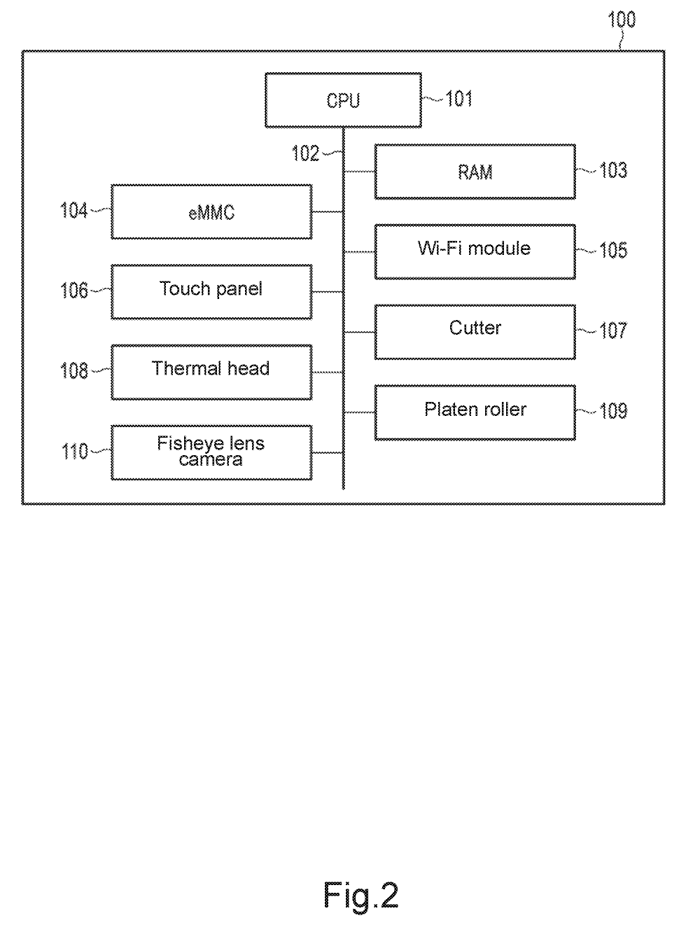

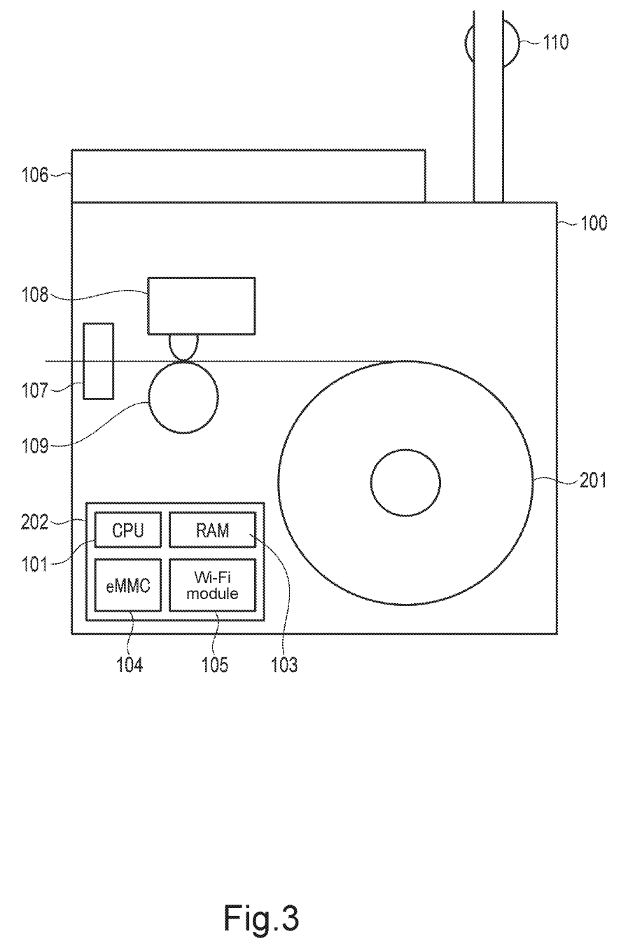

A configuration example of the mobile POS printer 100 will be described. FIG. 2 is a block diagram illustrating the mobile POS printer 100. FIG. 3 is a configuration diagram illustrating the mobile POS printer 100.

The mobile POS printer 100 includes a central processing unit (CPU) 101, a bus 102, a random access memory (RAM) 103, an embedded multi media card (eMMC) 104, a Wi-Fi module 105, a touch panel 106, a cutter 107, a thermal head 108, a platen roller 109, a fisheye lens camera 110, a thermal paper roll 201, and a control board 202.

The CPU 101 corresponds to a central part of the mobile POS printer 100. The CPU 101 is an element that constitutes a computer of the mobile POS printer 100. The CPU 101 loads a program stored in the eMMC 104 into the RAM 103. The CPU 101 enables various processes to be executed by executing the program loaded in the RAM 103.

The CPU 101 is an example of a processing circuit of the mobile POS printer 100. The processing circuit includes one or more arithmetic circuits that execute a plurality of processes by a plurality of functions. For example, the arithmetic circuit is a processor application specific integrated circuit (ASIC) or a field-programmable gate array (FPGA), though not limited thereto. For example, the processor is a CPU or a GPU (graphics processing unit), though not limited thereto.

The bus 102 is a signal line that enables signals to be input/output between elements of the mobile POS printer 100.

The RAM 103 corresponds to a main storage part of the mobile POS printer 100. The RAM 103 is an element that constitutes the computer of the mobile POS printer 100. The RAM 103 is a volatile memory area that is used as a work area where data is rewritten by the CPU 101 as appropriate.

The eMMC 104 stores software, data, and the like. For example, the eMMC 104 stores the control software that operates in the mobile POS printer 100. The eMMC 104 is capable of storing the update control software. The eMMC 104 is an example of storage of the mobile POS printer 100. The storage includes one or more storage devices. For example, the storage devices are eMMC, a Hard Disk Drive (HDD), and a Solid State Drive (SSD), or the like, though not limited thereto. The storage is an example of the storage part.

The Wi-Fi module 105 is a module for communicating with the Wi-Fi router 303 via Wi-Fi. The Wi-Fi module 105 is an example of a communication part of the mobile POS printer 100 for communicating with the mobile POS printer 100.

The touch panel 106 includes a display device and an input device. The display device is a device capable of displaying an image. The display device is a liquid-crystal display or an organic electroluminescence (EL) display, though not limited thereto. The input device is a device capable of inputting information or instruction based on the operation. The touch panel 106 is an example of a display part of the mobile POS printer 100 capable of displaying an image.

The cutter 107 cuts the thermal paper roll 201. The thermal head 108 is a heat generator that prints information on the thermal paper roll 201 by generating heat. The platen roller 109 is a roller that faces the thermal head 108 and conveys the thermal paper roll 201.

The fisheye lens camera 110 is a camera that includes a fisheye lens and captures an image of the periphery of the mobile POS printer 100. The fisheye lens camera 110 is an example of an image-capturing part of the mobile POS printer 100.

The thermal paper roll 201 is a medium on which the thermal head 108 prints information. A portion of the thermal paper roll 201, on which the information has been printed, is cut by the cutter 107 and is issued as a receipt.

The control board 202 is a board on which the CPU 101, the RAM 103, the eMMC 104, and the Wi-Fi module 105 are integrated.

It should be noted that the hardware configuration of the mobile POS printer 100 is not limited to the above-mentioned configuration. The mobile POS printer 100 enables omission and modification of the above-mentioned components and addition of new components as appropriate.

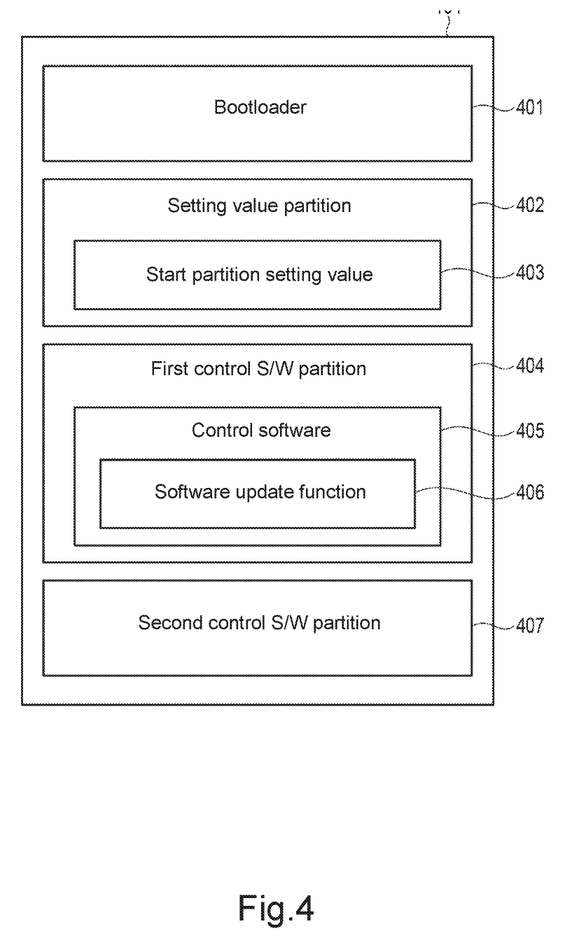

FIG. 4 is a diagram illustrating a partition configuration in the eMMC 104 of the mobile POS printer 100. The eMMC 104 includes a bootloader 401, a setting value partition 402, a first control software (S/W) partition 404, and a second control software (S/W) partition 407.

The bootloader 401 is a program for starting an operating system (OS).

The setting value partition 402 is a partition for storing a start partition setting value 403. The start partition setting value 403 is a value for setting a partition where software that is a start target has been stored. The start partition setting value 403 is a value for setting a first control software partition 404 or a value for setting a second control software partition 407. In a case where the start partition setting value 403 is a value for setting the first control software partition 404, the CPU 101 starts the software stored in the first control software partition 404. In a case where the start partition setting value 403 is a value for setting the second control software partition 407, the CPU 101 starts the software stored in the second control software partition 407.

The first control software partition 404 is a partition that stores the control software that operates in the mobile POS printer 100 or the update control software. Here, the first control software partition 404 has stored control software 405 that operates in the mobile POS printer 100. It should be noted that the first control software partition 404 has stored no software sometimes. The control software 405 has a software update function 406. The software update function 406 is a program (software update program) for updating the control software 405. The software update function 406 switches from the control software 405 before the update to the new control software after the update as the control software that operates in the mobile POS printer 100.

The second control software partition 407 is a partition for storing the control software that operates in the mobile POS printer 100 or the update control software. Here, the second control software partition 407 has stored no software.

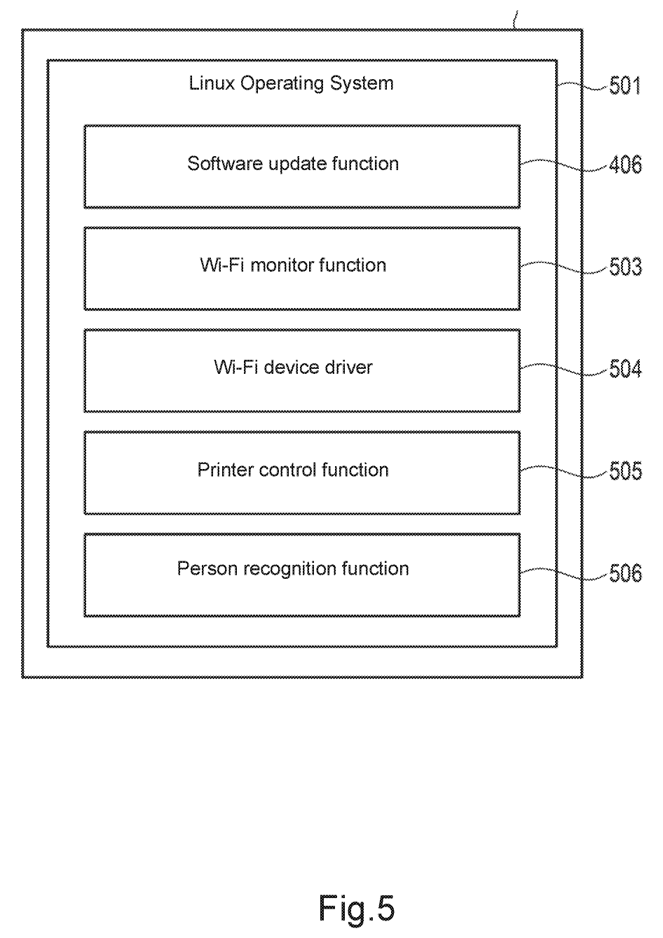

FIG. 5 is a diagram illustrating a software configuration of the control software 405. The control software 405 includes a Linux operating system 501. The Linux operating system 501 includes the above-mentioned software update function 406, a Wi-Fi monitor function 503, a Wi-Fi device driver 504, a printer control function 505, and a person recognition function 506.

The Wi-Fi monitor function 503 is a program (monitor program) for scanning a Wi-Fi probe request frame. A Wi-Fi probe request is a signal of a device using Wi-Fi at the store.

The Wi-Fi device driver 504 is a program for controlling the Wi-Fi module 105.

The printer control function 505 is a program (operation control program) for controlling printing using the cutter 107, the thermal head 108, and the platen roller 109, for example.

The person recognition function 506 is a program for recognizing a person from a camera image. The person recognition function 506 is also capable of identifying the person recognized from the camera image as a customer or clerk. The camera image is an image based on image-capturing by the fisheye lens camera 110. The camera image may be each image that constitutes the captured moving image or may be an image captured as a still image. The camera image is an example of the captured image based on the image-capturing by the fisheye lens camera 110.

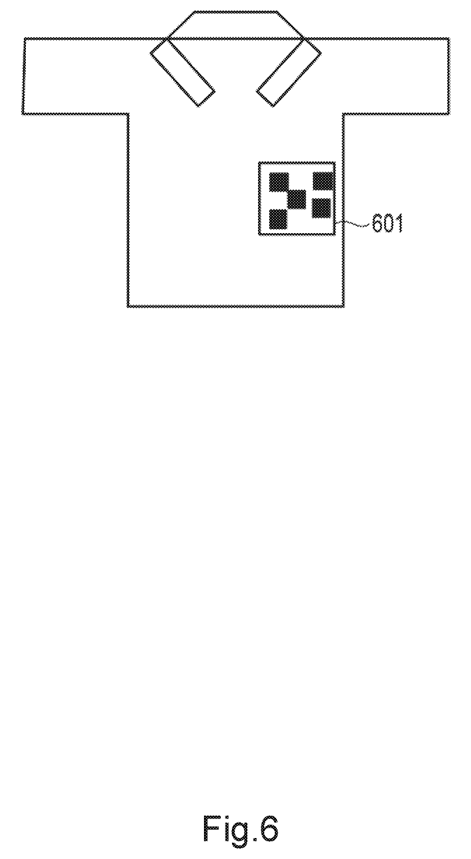

Clerk identification information capable of identifying a person used in the person recognition function 506 as a clerk will be described. FIG. 6 is a view illustrating a uniform of the clerk. A QR code (registered trademark) 601 is attached to an uniform of the clerk. The QR code 601 is a two-dimensional code that has recorded information for identifying a person wearing the uniform as a clerk. The QR code 601 is an example of the clerk identification information capable of identifying the person as a clerk. The clerk identification information is not limited to the QR code 601. The clerk identification information may be information, such as a pattern of the uniform worn by the clerk, or may be information on a physical feature, such as the face of the clerk.

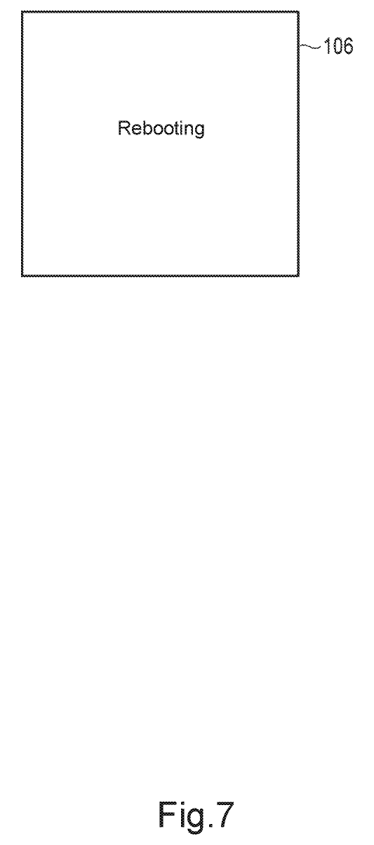

A display example of the touch panel 106, which is displayed during the reboot for updating the control software that operates in the mobile POS printer 100, will be described. FIG. 7 is a view illustrating a rebooting screen, which is displayed on the touch panel 106 of the mobile POS printer 100. In a case where the CPU 101 executes the reboot for updating the control software that operates in the mobile POS printer 100, the touch panel 106 displays a rebooting screen. The rebooting screen is a screen showing that the mobile POS printer 100 is rebooting.

### Process Example

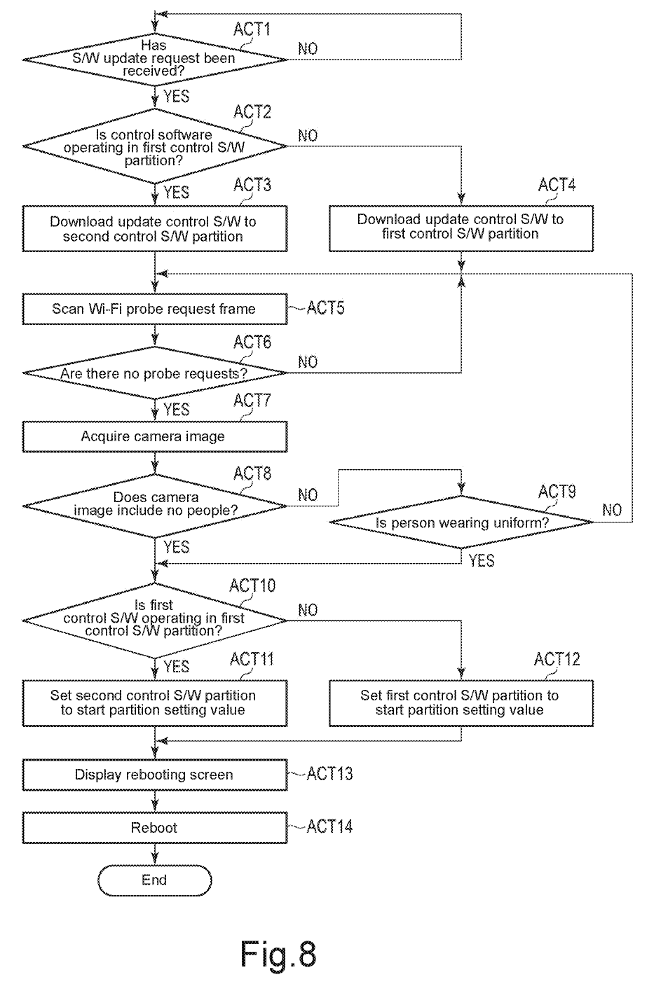

A process of the mobile POS printer 100 will be described. FIG. 8 is a flowchart illustrating an update process of the control software in the mobile POS printer 100. For example, the CPU 101 uses a nice command, which is a function of the Linux operating system 501, to set the update process to, for example, a numeric value (numeric value for changing the priority in the nice command) "19" with the lowest priority, and executes the update process. It should be noted that the process procedure to be described below is merely an example, and each process may be modified as necessary. Moreover, steps of the process procedure to be described below can be omitted, replaced, and added as appropriate in accordance with the embodiment.

The CPU 101 receives a software update request from the content server 301 via the NVA (ACT 1). ACT 1 may be a process by the software update function 406. In a case where the CPU 101 receives the software update request (YES in ACT 1), the process shifts from ACT 1 to ACT 2. In a case where the CPU 101 does not receive the software update request (NO in ACT 1), the CPU 101 waits for the software update request. The software update request is a request to update the control software that operates in the mobile POS printer 100.

The CPU 101 determines whether or not the control software is operating in the first control software partition 404 on the basis of the software update request (ACT 2). ACT 2 may be a process by the software update function 406. In ACT 2, for example, the CPU 101 determines whether or not the first control software partition 404 has stored the control software that operates in the mobile POS printer 100.

In a case where the control software is operating in the first control software partition 404 (YES in ACT 2), the process shifts from ACT 2 to ACT 3. In this case, the first control software partition 404 has stored the control software that operates in the mobile POS printer 100.

The CPU 101 downloads the update control software 302 to the second control software partition 407 from the content server 301 (ACT 3). ACT 3 may be a process by the software update function 406.

In a case where the control software is not operating in the first control software partition 404 (NO in ACT 2), the process shifts from ACT 2 to ACT 4. In this case, the second control software partition 407 has stored the control software that operates in the mobile POS printer 100.

The CPU 101 downloads the update control software 302 to the first control software partition 404 from the content server 301 (ACT 4). ACT 4 may be a process by the software update function 406.

The CPU 101 scans the Wi-Fi probe request frame on the basis of the downloading of the update control software 302 (ACT 5). ACT 5 may be a process by the Wi-Fi monitor function 503. The CPU 101 detects that there are no Wi-Fi probe requests or there is a Wi-Fi probe request on the basis of the scanning of the Wi-Fi probe request frame (ACT 6). ACT 6 may be a process by the Wi-Fi monitor function 503. In a case where no people possessing the device using Wi-Fi are present in the store, there are no Wi-Fi probe requests. On the other hand, in a case where a person possessing the device using Wi-Fi is present in the store, there is a Wi-Fi probe request.

In a case where there are no Wi-Fi probe requests (YES in ACT 6), the process shifts from ACT 6 to ACT 7. In a case where there is a Wi-Fi probe request (NO in ACT 6), the process shifts from ACT 6 to ACT 5. The CPU 101 repeats the processes of ACT 5 and ACT 6 until there are no more Wi-Fi probe requests.

In a case where there are no Wi-Fi probe requests, the CPU 101 detects that no customers are present within a predetermined area on the basis of the camera image as exemplified in ACT 7 to ACT 9. In this case, the clerk may be present within the predetermined area or may be absent within the predetermined area. The predetermined area may be an area including the entire store or may be an area that is a portion of the store.

The CPU 101 acquires a camera image from the fisheye lens camera 110 (ACT 7). ACT 7 may be a process by the person recognition function 506.

The CPU 101 detects that the camera image includes the person or that the camera image does not include the person on the basis of the camera image (ACT 8). ACT 8 may be a process by the person recognition function 506. In a case where at least one person is present within the predetermined area, the camera image includes the person. In a case where nobody is present within the predetermined area, the camera image does not include the person. In a case where the CPU 101 detects that the camera image includes the person (NO in ACT 8), the process shifts from ACT 8 to ACT 9. In a case where the CPU 101 detects that the camera image does not include the person (YES in ACT 8), the process shifts from ACT 8 to ACT 10. Detecting that the camera image does not include the person is an example of detecting that no customers are present within the predetermined area on the basis of the camera image.

The CPU 101 detects that the person included in the camera image is wearing the uniform of the store or that the person included in the camera image is not wearing the uniform (ACT 9). ACT 9 may be a process by the person recognition function 506. In ACT 9, for example, the CPU 101 detects that the person included in the camera image is wearing the uniform of the store or that the person included in the camera image is not wearing the uniform in accordance with whether or not the QR code 601 can be recognized from the clothes of the person included in the camera image. In a case where the person included in the camera image is wearing the uniform of the store, the person included in the camera image is a clerk. In a case where the person included in the camera image is not wearing the uniform of the store, the person included in the camera image is a customer.

In a case where the CPU 101 recognizes the QR code 601, the CPU 101 detects that the person included in the camera image is wearing the uniform of the store. In this manner, the CPU 101 detects that no customers are present within the predetermined area by identification of the customer or clerk based on the camera image. Detecting that no customers are present within the predetermined area by identification of the customer or clerk based on the camera image is an example of detecting that no customers are present within the predetermined area on the basis of the camera image.

In a case where the CPU 101 does not recognize the QR code 601, the CPU 101 detects that the person included in the camera image is not wearing the uniform of the store. In this manner, the CPU 101 detects that the customer is present within the predetermined area by identification of the customer or clerk based on the camera image. Detecting that the customer is present within the predetermined area by identification of the customer or clerk based on the camera image is an example of detecting that the customer is present within the predetermined area on the basis of the camera image.

In a case where the CPU 101 detects that the person included in the camera image is wearing the uniform of the store (YES in ACT 9), the process shifts from ACT 9 to ACT 10. In a case where the CPU 101 detects that the person included in the camera image is not wearing the uniform of the store (NO in ACT 9), the process shifts from ACT 9 to ACT 5.

As exemplified in ACT 10 to ACT 14, the CPU 101 executes the reboot for updating the control software that operates in the mobile POS printer 100. Here, the CPU 101 executes the reboot on the basis of detection that no customers are present within the predetermined area.

The CPU 101 determines whether or not the control software is operating in the first control software partition 404 (ACT 10). ACT 10 may be a process by the software update function 406. In ACT 10, for example, the CPU 101 determines whether or not the first control software partition 404 has stored the control software that operates in the mobile POS printer 100.

In a case where the control software is operating in the first control software partition 404 (YES in ACT 10), the process shifts from ACT 10 to ACT 11. In this case, the first control software partition 404 has stored the control software that operates in the mobile POS printer 100. The second control software partition 407 has stored the update control software (see ACT 3 described above).

The CPU 101 sets the second control software partition 407 to the start partition setting value 403 (ACT 11). ACT 11 may be a process by the software update function 406. Accordingly, the CPU 101 is capable of setting the update control software, which has been stored in the second control software partition 407, as a start target.

In a case where the control software is not operating in the first control software partition 404 (NO in ACT 10), the process shifts from ACT 10 to ACT 12. In this case, the second control software partition 407 has stored the control software that operates in the mobile POS printer 100. The first control software partition 404 has stored the update control software (see ACT 4 described above).

The CPU 101 sets the first control software partition 404 to the start partition setting value 403 (ACT 12). ACT 12 may be a process by the software update function 406. Accordingly, the CPU 101 is capable of setting the update control software, which has been stored in the first control software partition 404, as a start target.

The CPU 101 causes the touch panel 106 to display the rebooting screen on the basis of the setting of the start partition setting value 403 (ACT 13). ACT 13 may be a process by the software update function 406.

The CPU 101 executes the reboot for updating the control software that operates in the mobile POS printer 100 (ACT 14). ACT 14 may be a process by the software update function 406. The CPU 101 switches to the new control software after the update (downloaded update control software 302 as described above) from the control software 405 before the update by the reboot of the mobile POS printer 100.

It should be noted that in ACT 5 and ACT 6, the CPU 101 performs processes for the Wi-Fi probe request, though not limited thereto. For the Wi-Fi probe request in ACT 5 and ACT 6, the processes may be omitted. In this example, on the basis of the downloading of the update control software 302, the CPU 101 detects that no customers are present within the predetermined area on the basis of the camera image.

It should be noted that In ACT 7 to ACT 9, the CPU 101 detects that no customers are present within the predetermined area on the basis of the camera image, though not limited thereto. The CPU 101 may detect that no customers are present within the predetermined area on the basis of the Wi-Fi probe request instead of the camera image. In this example, the processes of ACT 7 to ACT 9 are omitted. In ACT 6, the CPU 101 detects that there are no Wi-Fi probe requests or there is a Wi-Fi probe request on the basis of the scanning of the Wi-Fi probe request frame. In a case where there are no Wi-Fi probe requests, the CPU 101 performs the process of ACT 10. Detecting that there are no Wi-Fi probe requests is an example of detecting that no customers are present within the predetermined area on the basis of the Wi-Fi probe request. In a case where there are no Wi-Fi probe requests, the CPU 101 performs the process of ACT 10.

In a case where there is a Wi-Fi probe request, the CPU 101 identifies whether the person possessing the device using Wi-Fi is a customer or clerk on the basis of the Wi-Fi probe request. In this case, the eMMC 104 of the mobile POS printer 100 stores information for identifying the device possessed by the clerk. The CPU 101 compares the information contained in the Wi-Fi probe request with the information for identifying the device possessed by the clerk, which has been stored in the eMMC 104. The CPU 101 identifies whether the person possessing the device using Wi-Fi is a customer or clerk by comparison.

Identifying that the person possessing the device using Wi-Fi as a clerk is an example of detecting that no customers are present within the predetermined area by identification of the customer or clerk based on the Wi-Fi probe request. Detecting that no customers are present within the predetermined area by identification of the customer or clerk based on the Wi-Fi probe request is an example of detecting that no customers are present within the predetermined area on the basis of the Wi-Fi probe request. In a case where the person possessing the device using Wi-Fi is identified as a clerk, the CPU 101 performs the process of ACT 10. Identifying that the person possessing the device using Wi-Fi as a customer is an example of detecting that the customer is present within the predetermined area by identification of the customer or clerk based on the Wi-Fi probe request. Detecting that the customer is present within the predetermined area by identification of the customer or clerk based on the Wi-Fi probe request is an example of detecting that the customer is present within the predetermined area on the basis of the Wi-Fi probe request. In a case where the person possessing the device using Wi-Fi is identified as a customer, the CPU 101 performs the process of ACT 5. As described above, the CPU 101 is capable of executing the reboot for updating the control software on the basis of detection that no customers are present within the predetermined area. Accordingly, the CPU 101 is capable of controlling the timing of the reboot for updating the software. For example, the CPU 101 proceeds with the executable update process, such as downloading the update control software, without stopping the mobile POS printer 100. In a case where a customer is present within the predetermined area, the CPU 101 stands by without executing the reboot. In a case where no customers are present within the predetermined area, the CPU 101 executes the reboot. The stop time of the mobile POS printer 100 due to the update of the control software is a time for which no customers are present within the predetermined area. The CPU 101 is capable of completing the update of the control software while no customers are present within the predetermined area. Therefore, even when the mobile POS printer 100 stops due to the update of the control software, the convenience of using the mobile POS printer 100 by customers is not decreased.

As described above, the CPU 101 is capable of detecting that no customers are present within the predetermined area by identification of the customer or clerk. Accordingly, since the CPU 101 identifies the person present within the predetermined area as a customer or clerk, the CPU 101 is capable of increasing the accuracy of detection that no customers are present within the predetermined area.

As described above, the CPU 101 is capable of detecting that no customers are present within the predetermined area on the basis of the camera image. Accordingly, the CPU 101 is capable of increasing the accuracy of detection that no customers are present within the predetermined area by recognizing a person from the camera image.

As described above, in a case where there are no probe requests of the wireless LAN, the CPU 101 is capable of detecting that no customers are present within the predetermined area on the basis of the camera image. Since the CPU 101 does not need to constantly execute the process for recognizing a person from the camera image, the CPU 101 is capable of reducing the processing load.

As described above, the CPU 101 is capable of detecting that no customers are present within the predetermined area on the basis of the probe request of the wireless LAN. The CPU 101 is capable of detecting that no customers are present within the predetermined area without using special devices.

It should be noted that in the above description referring to FIG. 8, the example in which the CPU 101 detects that no customers are present within the predetermined area has been described, though not limited thereto. The CPU 101 may detect that no people are present within the predetermined area without distinguishing customers from clerks. In this example, in the flowchart illustrated in FIG. 8, ACT 9 is omitted. Therefore, in a case where the CPU 101 detects that the camera image includes the person in ACT 8 (NO in ACT 8), the process shifts from ACT 8 to ACT 5. The citation, "that no customers are present within the predetermined area," in the above description referring to FIG. 8 may be interpreted as "that no people are present within the predetermined area." The citation, "that the customer is present within the predetermined area," in the above description referring to FIG. 8, may be interpreted as "that a person is present within the predetermined area." It should be noted that for the Wi-Fi probe request in ACT 5 and ACT 6, the processes may be omitted. In this example, the CPU 101 detects that no people are present within the predetermined area on the basis of the camera image after downloading the update control software 302.

In this example, the CPU 101 is capable of executing the reboot for updating the control software on the basis of detection that no people are present within the predetermined area. Accordingly, the CPU 101 is capable of controlling the timing of the reboot for updating the software. For example, the CPU 101 is capable of completing the update of the control software while no people are present within the predetermined area. Therefore, even if the mobile POS printer 100 stops due to the update of the control software, the convenience of using the mobile POS printer 100 by people is not decreased.

The CPU 101 is capable of detecting that no people are present within the predetermined area on the basis of the camera image. Accordingly, the CPU 101 is capable of increasing the accuracy of detection that no people are present within the predetermined area by recognizing a person from the camera image.

In a case where there are no probe requests of the wireless LAN, the CPU 101 is capable of detecting that no people are present within the predetermined area on the basis of the camera image. Accordingly, since the CPU 101 does not need to constantly execute the process for recognizing a person from the camera image, the CPU 101 is capable of reducing the processing load.

The CPU 101 may detect that no people are present within the predetermined area on the basis of the Wi-Fi probe request instead of the camera image. The process in this case is similar to the above-mentioned process. Accordingly, the CPU 101 is capable of detecting that no people are present within the predetermined area without using special devices.

### Second Embodiment

A second embodiment is an embodiment in which the control device detects that no people are present within the predetermined area, linking to another device. Descriptions of portions in the second embodiment, which may be the same as those of the first embodiment, will be omitted by using the same reference signs or the same terms.

### Configuration Example

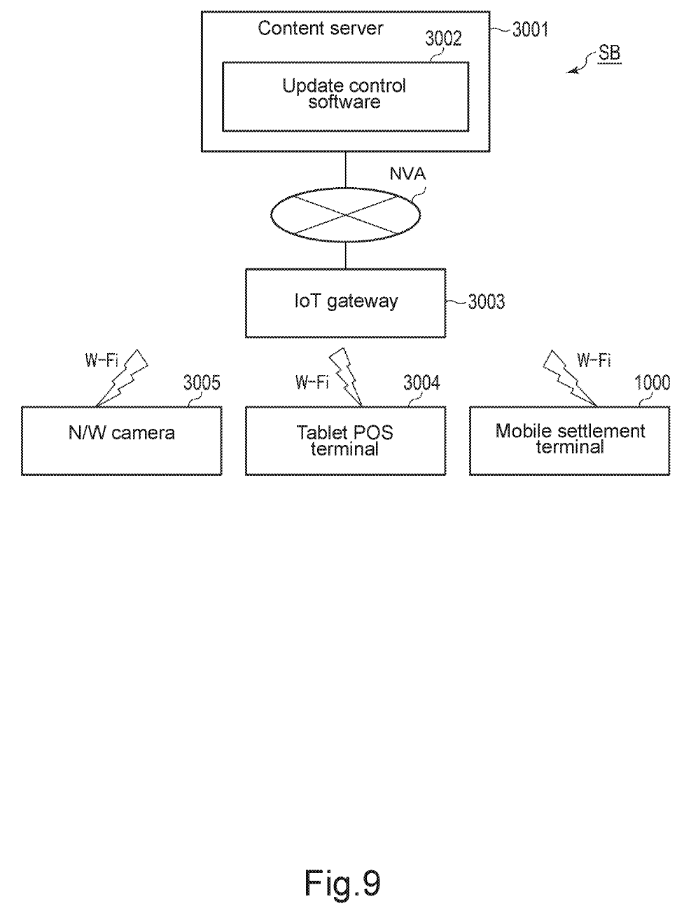

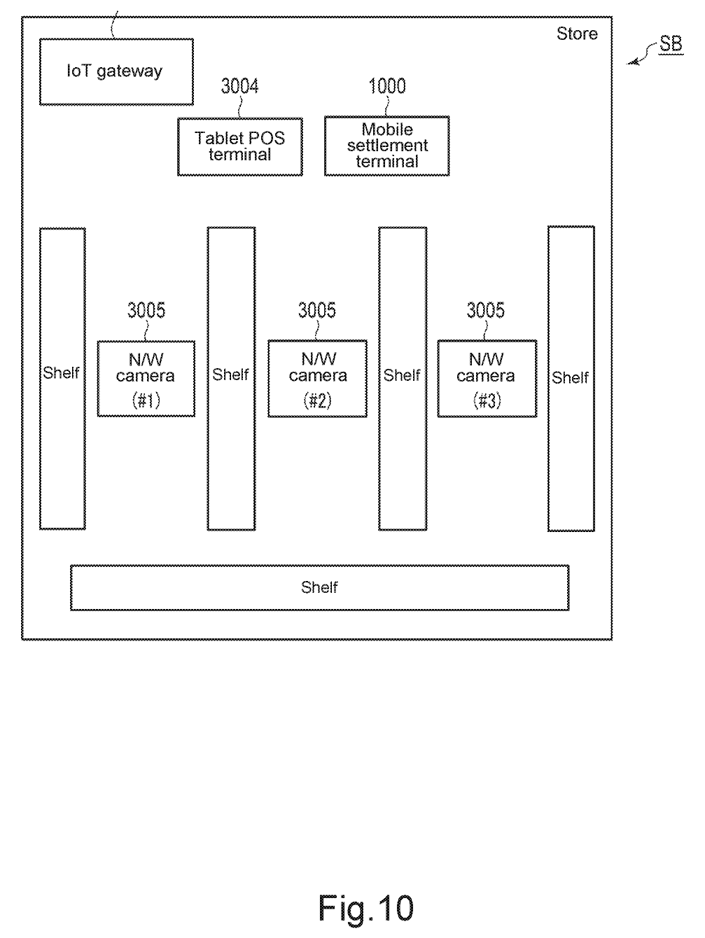

FIG. 9 is a block diagram showing a schematic configuration example of a system SB. FIG. 10 is a block diagram showing a schematic configuration example of a store in the system SB. The system SB is a system for updating control software in a control device capable of executing control on the basis of the control software.

The system SB includes a mobile settlement terminal 1000, an internet of things (IoT) gateway 3003, a tablet POS terminal 3004, a network (N/W) camera 3005, and a content server 3001. The mobile settlement terminal 1000, the IoT gateway 3003, the tablet POS terminal 3004, and the network camera 3005 are devices in the store. The content server 3001 is a device outside the store. The content server 3001 may be a cloud server. The system SB is an example of a system including at least two devices of the mobile settlement terminal 1000, the IoT gateway 3003, the tablet POS terminal 3004, the network camera 3005, and the content server 3001.

The mobile settlement terminal 1000 is a device capable of processing settlement of a transaction at the store. The settlement is payment for the transaction. The settlement means check-out. The mobile settlement terminal 1000 is a device that is used by the customer. The mobile settlement terminal 1000 is a portable device. The mobile settlement terminal 1000 is a device capable of executing print control as the control based on the control software. The mobile settlement terminal 1000 is an example of the control device. The system SB may include one or more mobile settlement terminals 1000.

The IoT gateway 3003 is a device capable of communicating with another device via the Wi-Fi. The IoT gateway 3003 is capable of connecting another device that performs communication via the Wi-Fi to an NVA. The system SB may include one or more IoT gateways 3003. The IoT gateway 3003 is an example of a communication device capable of communicating with another device.

The tablet POS terminal 3004 is a device capable of displaying the information regarding the transactions at the store. The tablet POS terminal 3004 is a device that is used by the clerk. The tablet POS terminal 3004 is a portable device. The system SB may include one or more tablet POS terminals 3004.

The network camera 3005 is a camera that captures an image of the periphery. The network camera 3005 is a device capable of communicating with the IoT gateway 3003 via the Wi-Fi. The network camera 3005 is an example of an image-capturing device that captures an image. The system SB may include one or more network cameras 3005. Here, it is assumed that the system SB includes three network cameras 3005 identified by identification numbers #1 to #3. The three network cameras 3005 captures an image of a different area in the store.

The content server 3001 is a device that manages update control software 3002, which can be used in the mobile settlement terminal 1000. The update control software 3002 is software for switching from the control software before the update to the new control software after the update as control software that operates in the mobile settlement terminal 1000. The control software that operates in the mobile settlement terminal 1000 is control software used in the mobile settlement terminal 1000.

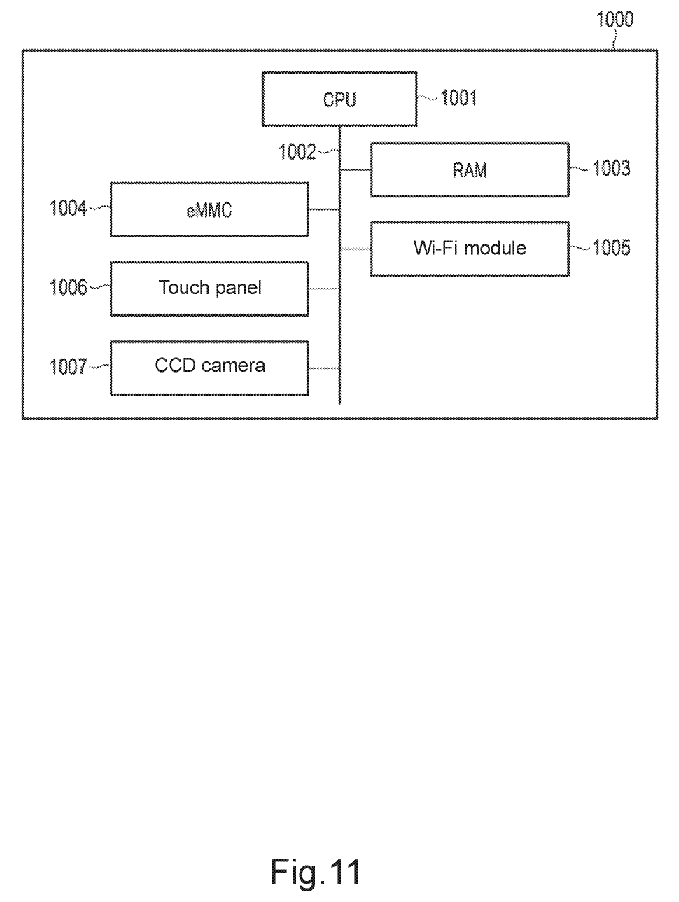

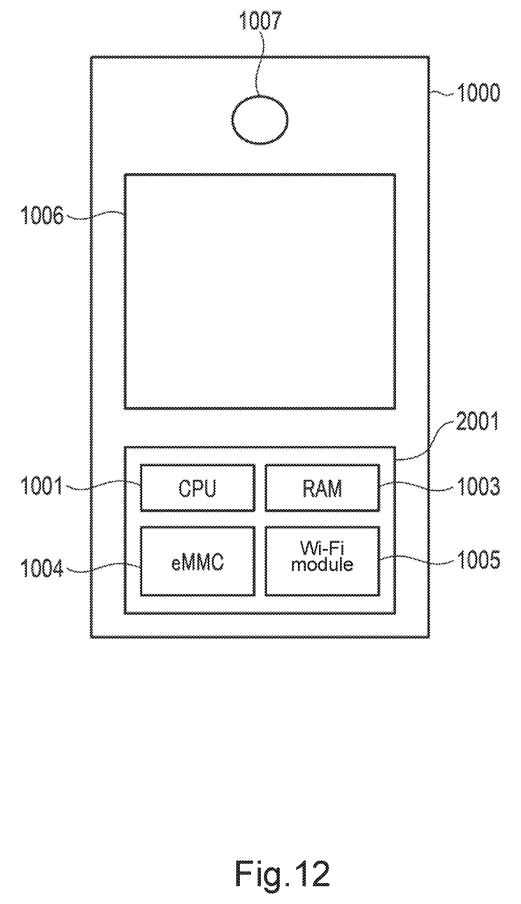

A configuration example of the mobile settlement terminal 1000 will be described. FIG. 11 is a block diagram illustrating the mobile settlement terminal 1000. FIG. 12 is a configuration diagram illustrating the mobile settlement terminal 1000.

The mobile settlement terminal 1000 includes a CPU 1001, a bus 1002, a RAM 1003, an eMMC 1004, a Wi-Fi module 1005, a touch panel 1006, a charge coupled device (CCD) camera 1007, and a control board 2001.

The CPU 1001 corresponds to a central part of the mobile settlement terminal 1000. The CPU 1001 is an element that constitutes a computer of the mobile settlement terminal 1000. The CPU 1001 loads the program stored in the eMMC 1004 into the RAM 1003. The CPU 1001 enables various processes to be executed by executing the program loaded in the RAM 1003. The CPU 1001 is an example of a processing circuit of the mobile settlement terminal 1000.

The bus 1002 is a signal line that enables signals to be input/output between elements of the mobile settlement terminal 1000.

The RAM 1003 corresponds to a main storage part of the mobile settlement terminal 1000. The RAM 1003 is an element that constitutes the computer of the mobile settlement terminal 1000. The RAM 1003 is a volatile memory area that is used as a work area where data is rewritten by the CPU 1001 as appropriate.

The eMMC 1004 stores software, data, and the like. For example, the eMMC 1004 stores the control software that operates in the mobile settlement terminal 1000. The eMMC 1004 is capable of storing the update control software. The eMMC 1004 is an example of storage of the mobile settlement terminal 1000.

The Wi-Fi module 1005 is a module for communicating with the IoT gateway 3003 via the Wi-Fi. The Wi-Fi module 1005 is an example of a communication part of the mobile settlement terminal 1000 that communicates with another device.

The touch panel 1006 includes a display device and an input device. The touch panel 1006 is an example of a display part of the mobile settlement terminal 1000 that is capable of displaying an image.

The CCD camera 1007 is a camera that captures an image of the periphery of the mobile settlement terminal 1000. The CCD camera 1007 is an example of an image-capturing part of the mobile settlement terminal 1000.

The control board 2001 is a board on which the CPU 1001, the RAM 1003, the eMMC 1004, and the Wi-Fi module 1005 are integrated.

It should be noted that the hardware configuration of the mobile settlement terminal 1000 is not limited to the above-mentioned configuration. The mobile settlement terminal 1000 enables omission and modification of the above-mentioned components and addition of new components as appropriate.

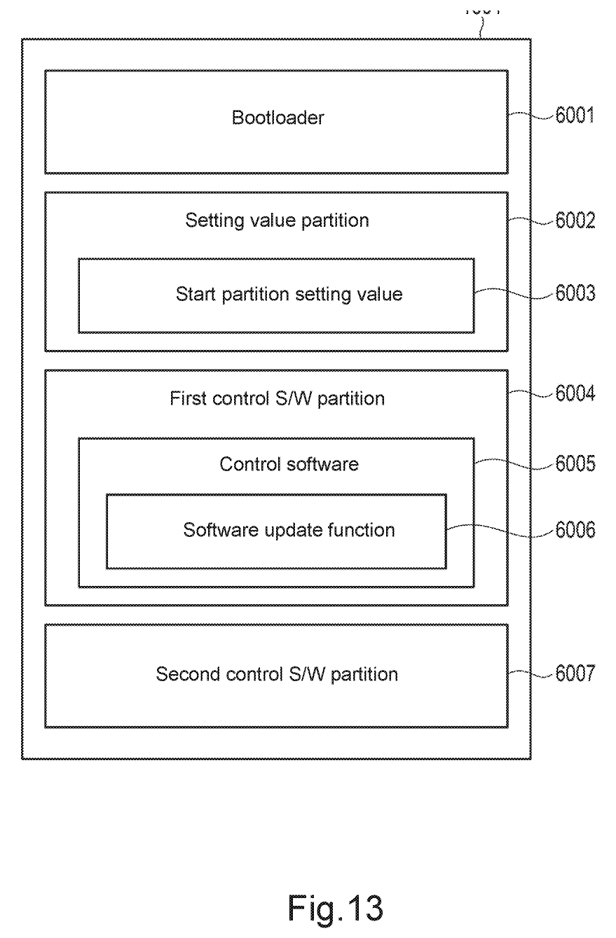

FIG. 13 is a diagram illustrating a partition configuration in the eMMC 1004 of the mobile settlement terminal 1000. The eMMC 1004 includes a bootloader 6001, a setting value partition 6002, a first control software (S/W) partition 6004, and a second control software (S/W) partition 6007.

The bootloader 6001 is a program for starting OS.

The setting value partition 6002 is a partition for storing a start partition setting value 6003. The start partition setting value 6003 is a value for setting a partition where software that is a start target has been stored. The start partition setting value 6003 is a value for setting a first control software partition 6004 or a value for setting a second control software partition 6007.

The first control software partition 6004 is a partition for storing the control software that operates in the mobile settlement terminal 1000 or the update control software. Here, the first control software partition 6004 has stored control software 6005 that operates in the mobile settlement terminal 1000. It should be noted that the first control software partition 6004 has stored no software sometimes. The control software 6005 includes a software update function 6006. The software update function 6006 is a program for updating the control software 6005. The software update function 606 switches to new control software after the update from control software before the update 6005 as the control software that operates in the mobile settlement terminal 1000.

The second control software partition 6007 is a partition for storing the control software that operates in the mobile settlement terminal 1000 or the update control software. Here, the second control software partition 6007 has stored no software.

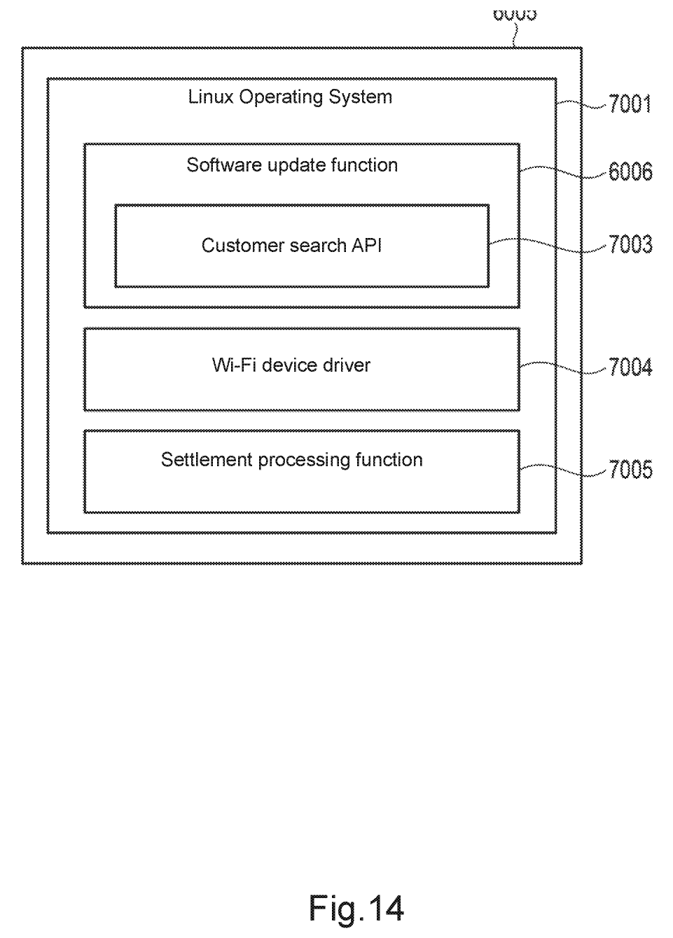

FIG. 14 is a diagram illustrating a software configuration of the control software 6005. The control software 6005 includes a Linux operating system 7001. The Linux operating system 7001 includes the above-mentioned software update function 6006, a Wi-Fi device driver 7004, and a settlement processing function 7005.

The software update function 6006 includes a customer search application programming interface (API) 7003. The customer search API 7003 is an API for linking the software update function 6006 to a function of detecting a person by the IoT gateway 3003.

The Wi-Fi device driver 7004 is a program for controlling the Wi-Fi module 1005.

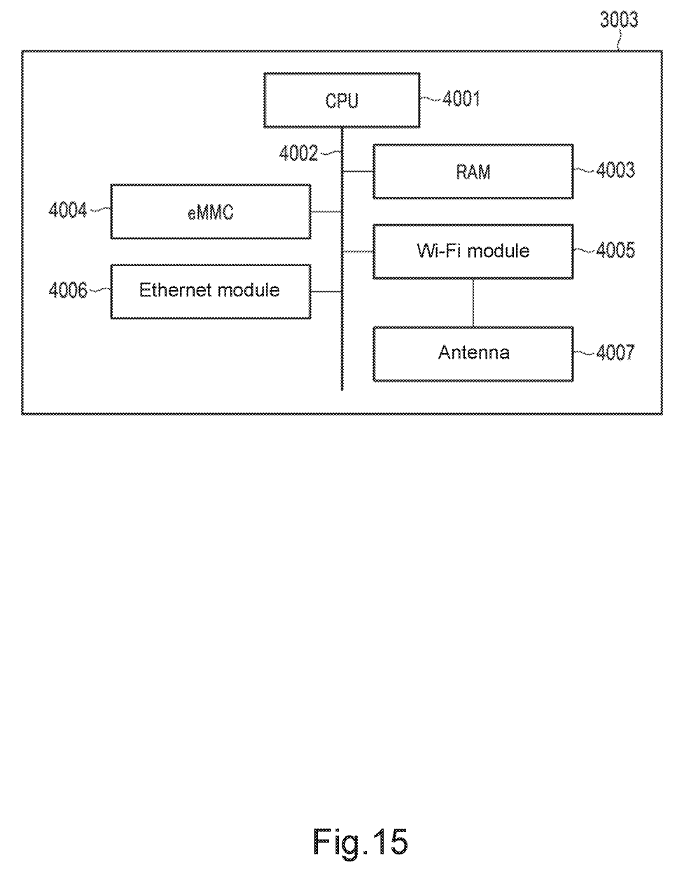

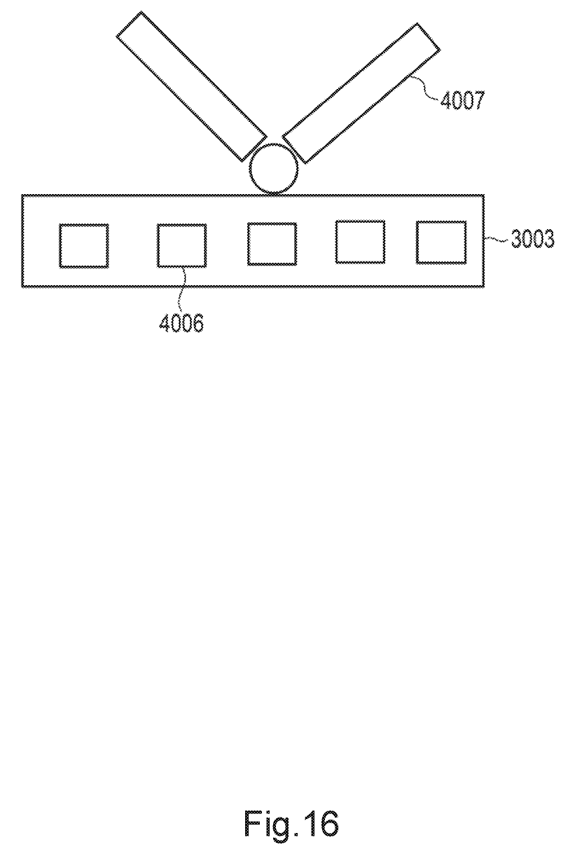

The settlement processing function 7005 is a program for processing settlement of a transaction at the store. A configuration example of the IoT gateway 3003 will be described. FIG. 15 is a block diagram illustrating the IoT gateway 3003. FIG. 16 is an external view illustrating the IoT gateway 3003.

The IoT gateway 3003 includes a CPU 4001, a bus 4002, a RAM 4003, an eMMC 4004, a Wi-Fi module 4005, an Ethernet module 4006, and an antenna 4007.

The CPU 4001 corresponds to a central part of the IoT gateway 3003. The CPU 4001 is an element that constitutes a computer of the IoT gateway 3003. The CPU 4001 loads a program stored in the eMMC 4004 into the RAM 4003. The CPU 4001 enables various processes to be executed by executing the program loaded in the RAM 4003. The CPU 4001 is an example of a processing circuit of the IoT gateway 3003.

The bus 4002 is a signal line that enables signals to be input/output between elements of the IoT gateway 3003.

The RAM 4003 corresponds to a main storage part of the IoT gateway 3003. The RAM 4003 is an element that constitutes a computer of the IoT gateway 3003. The RAM 4003 is a volatile memory area that is used as a work area where data is rewritten by the CPU 4001 as appropriate.

The eMMC 4004 stores software, data, and the like. The eMMC 4004 is an example of storage of the IoT gateway 3003.

The Wi-Fi module 4005 is a module for communicating with another device via the Wi-Fi. The Wi-Fi module 4005 is an example of a communication part of the IoT gateway 3003 for communicating with another device.

The Ethernet module 4006 is a module for connecting the IoT gateway 3003 to a network.

The antenna 4007 is an antenna for communication by Wi-Fi.

It should be noted that the hardware configuration of the IoT gateway 3003 is not limited to the above configuration. The IoT gateway 3003 enables omission and modification of the above-mentioned components and addition of new components as appropriate.

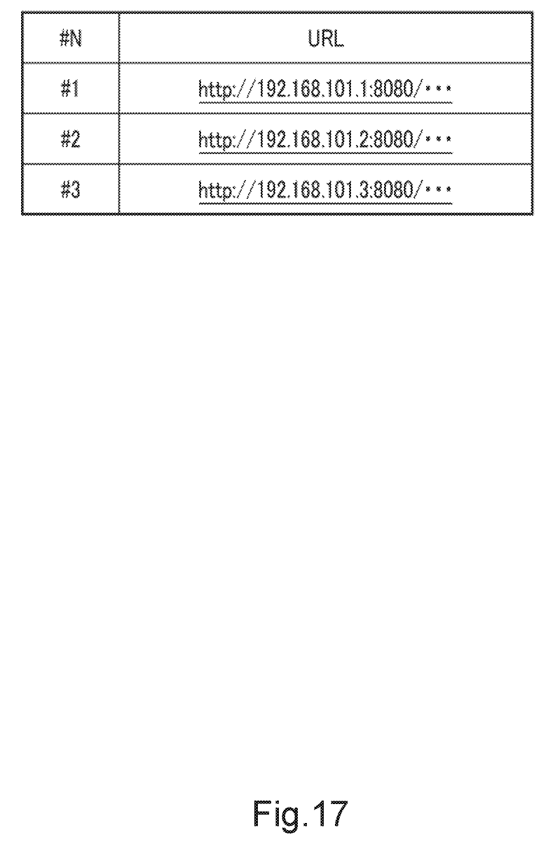

Uniform resource locator (URL) information of the network camera 3005 that has stored in the eMMC 4004 of the IoT gateway 3003 will be described. FIG. 17 is a diagram illustrating URL information of the network camera 3005. The eMMC 4004 of the IoT gateway 3003 stores URL information associated with the identification number (#N) of the network camera 3005 with respect to each network camera 3005 in the store. The identification number (#N) is identification information capable of identifying each network camera 3005. The URL information is access destination information for downloading a camera image from the network camera 3005. The camera image is an image based on image-capturing by the network camera 3005. The camera image may be each image that constitutes a captured moving image or may be an image captured as a still image. The camera image is an example of a captured image based on image-capturing by the network camera 3005.

Clerk identification information capable of identifying a person as a clerk, which is used for detecting the person by the IoT gateway 3003, will be described.

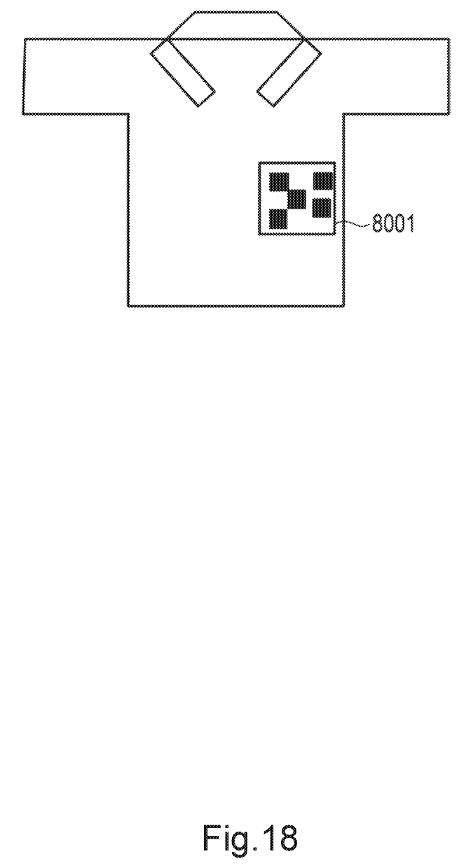

FIG. 18 is a view illustrating a uniform of the clerk. A QR code 8001 is attached to the uniform of the clerk. The QR code 8001 is a two-dimensional code that has recorded information for identifying a person wearing the uniform as a clerk. The QR code 8001 is an example of the clerk identification information capable of identifying the person as a clerk. The clerk identification information is not limited to the QR code 8001. The clerk identification information may be information, such as a pattern of the uniform worn by the clerk, or may be information on a physical feature, such as the face of the clerk.

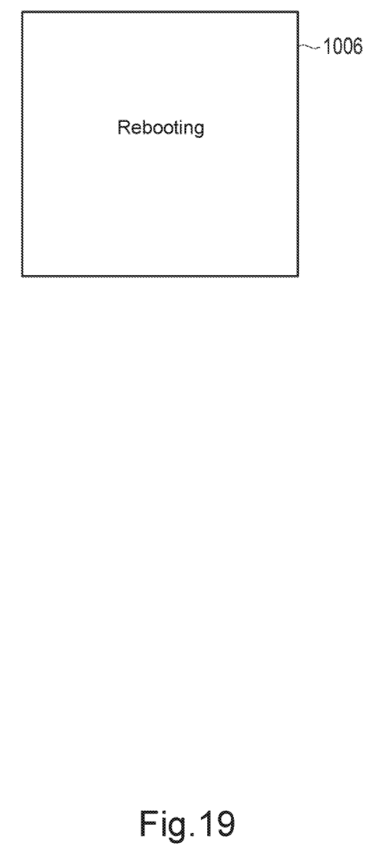

A display example of the touch panel 1006, which is displayed during the reboot for updating the control software that operates in the mobile settlement terminal 1000 will be described. FIG. 19 is a view illustrating a rebooting screen, which is displayed on the touch panel 1006 of the mobile settlement terminal 1000. In a case where the CPU 1001 executes the reboot for updating the control software that operates in the mobile settlement terminal 1000, the touch panel 1006 displays a rebooting screen. The rebooting screen is a screen showing that the mobile settlement terminal 1000 is rebooting.

### Process Example

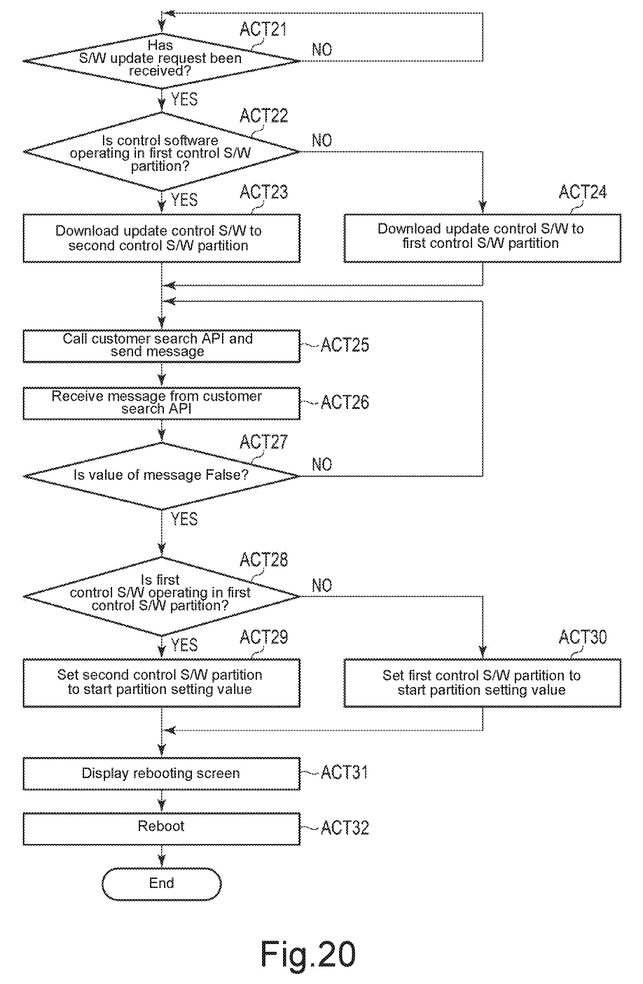

A process of the mobile settlement terminal 1000 will be described. FIG. 20 is a flowchart illustrating an update process of the control software in the mobile settlement terminal 1000. For example, the CPU 1001 uses a nice command, which is a function of the Linux operating system 7001, to set the update process to 19 with a low priority, and executes update process. The process procedure to be described below can be a process by the software update function 6006. It should be noted that the process procedure to be described below is merely an example, and each process may be modified as necessary. Moreover, steps of the process procedure to be described below can be omitted, replaced, and added as appropriate in accordance with the embodiment.

The CPU 1001 receives a software update request from the content server 3001 via the NVA (ACT 21). In a case where the CPU 1001 receives the software update request (YES in ACT 21), the process shifts from ACT 21 to ACT 22. In a case where the CPU 1001 does not receive the software update request (NO in ACT 21), the CPU 1001 waits for the software update request. The software update request is a request to update the control software that operates in the mobile settlement terminal 1000.

The CPU 1001 determines whether or not the control software is operating in the first control software partition 6004 on the basis of the software update request (ACT 22). In ACT 22, for example, the CPU 1001 determines whether or not the first control software partition 6004 has stored the control software that operates in the mobile settlement terminal 1000.

In a case where the control software is operating in the first control software partition 6004 (YES in ACT 22), the process shifts from ACT 22 to ACT 23. In this case, the first control software partition 6004 has stored the control software that operates in the mobile settlement terminal 1000.

The CPU 1001 downloads the update control software 3002 to the second control software partition 6007 from the content server 3001 (ACT 23).

In a case where the control software is not operating in the first control software partition 6004 (NO in ACT 22), the process shifts from ACT 22 to ACT 24. In this case, the second control software partition 6007 has stored the control software that operates in the mobile settlement terminal 1000.

The CPU 1001 downloads the update control software 3002 to the first control software partition 6004 from the content server 3001 (ACT 24).

The CPU 1001 calls the customer search API 7003 and sends a first message to the IoT gateway 3003 on the basis of the downloading of the update control software 3002 (ACT 25). The first message is a message that is sent to the IoT gateway 3003 from the mobile settlement terminal 1000. The first message is a message to request a detection result indicating that no customers are present within the predetermined area or that the customer is present within the predetermined area.

The CPU 1001 receives a second message from the customer search API 7003 (ACT 26). In ACT 25, for example, the CPU 1001 receives the second message from the IoT gateway 3003 via the customer search API 7003. The second message is a message that is sent to the mobile settlement terminal 1000 from the IoT gateway 3003. The second message is True or False. True of the second message is a detection result indicating that the customer is present within the predetermined area. False of the second message is a detection result indicating that no customers are present within the predetermined area. In a case where the CPU 4001 of the IoT gateway 3003 detects that the customer is present within the predetermined area, the CPU 1001 receives True as the second message from the IoT gateway 3003. In a case where the CPU 4001 of the IoT gateway 3003 detects that no customers are present within the predetermined area, the CPU 1001 receives False as the second message from the IoT gateway 3003.

The CPU 1001 detects that the value of the second message is False or the value of the second message is True (ACT 27). Detecting that the value of the second message is False is an example of detecting that no customers are present within the predetermined area on the basis of False of the second message. Detecting that the value of the second message is True is an example of detecting that the customer is present within the predetermined area on the basis of True of the second message. In a case where the CPU 1001 detects that the value of the second message is False (YES in ACT 27), the process shifts from ACT 27 to ACT 28. In a case where the value of the second message is True (NO in ACT 27), the process shifts from ACT 27 to ACT 25.

As exemplified in ACT 28 to ACT 32, the CPU 1001 executes the reboot for updating the control software that operates in the mobile settlement terminal 1000. Here, the CPU 1001 executes the reboot on the basis of detection that no customers are present within the predetermined area.

The CPU 1001 determines whether or not the control software is operating in the first control software partition 6004 (ACT 28). In ACT 28, for example, the CPU 1001 determines whether or not the first control software partition 6004 has stored the control software that operates in the mobile settlement terminal 1000.

In a case where the control software is operating in the first control software partition 6004 (YES in ACT 28), the process shifts from ACT 28 to ACT 29. In this case, the first control software partition 6004 has stored the control software that operates in the mobile settlement terminal 1000. The second control software partition 6007 has stored the update control software.

The CPU 1001 sets the second control software partition 6007 to the start partition setting value 6003 (ACT 29). Accordingly, the CPU 1001 is capable of setting the update control software, which has been stored in the second control software partition 6007, as a start target.

In a case where the control software is not operating in the first control software partition 6004 (NO in ACT 28), the process shifts from ACT 28 to ACT 30. In this case, the second control software partition 6007 has stored the control software that operates in the mobile settlement terminal 1000. The first control software partition 6004 has stored the update control software.

The CPU 1001 sets the first control software partition 6004 to the start partition setting value 6003 (ACT 30). Accordingly, the CPU 1001 is capable of setting the update control software, which has been stored in the first control software partition 6004, as a start target.

The CPU 1001 causes the touch panel 1006 to display the rebooting screen on the basis of the setting of the start partition setting value 6003 (ACT 31).

The CPU 1001 executes the reboot for updating the control software that operates in the mobile settlement terminal 1000 (ACT 32). The CPU 1001 switches to the new control software after the update from the control software before the update 6005 by the reboot of the mobile settlement terminal 1000.

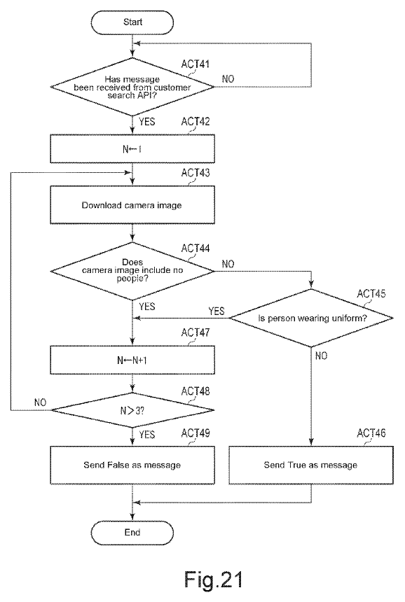

A process of the IoT gateway 3003 will be described. FIG. 21 is a flowchart illustrating a process of the customer search API in the IoT gateway 3003. It should be noted that the process procedure to be described below is merely an example, and each process may be modified as necessary. Moreover, steps of the process procedure to be described below can be omitted, replaced, and added as appropriate in accordance with the embodiment.

The CPU 4001 receives a first message from the customer search API (ACT 41). In ACT 41, for example, the CPU 4001 receives the first message from the mobile settlement terminal 1000. In a case where the CPU 4001 receives the first message (YES in ACT 41), the process shifts from ACT 41 to ACT 42. In a case where the CPU 4001 does not receive the first message (NO in ACT 41), the CPU 4001 waits for the first message.

The CPU 4001 sets an identification number #N of the network camera 3005 to one on the basis of the first message (ACT 42).

The CPU 4001 downloads a camera image from the network camera 3005 identified by the identification number #N where a value has been set to N (ACT 43). In ACT 43, for example, the CPU 4001 acquires URL information associated with the identification number #N where the value has been set to N from the eMMC 4004. The CPU 4001 accesses the network camera 3005 on the basis of the acquired URL information. The CPU 4001 downloads a camera image from the accessed network camera 3005.

The CPU 4001 detects that the camera image includes the person or that the camera image does not include the person on the basis of the camera image (ACT 44). In a case where the CPU 4001 detects that the camera image includes the person (NO in ACT 44), the process shifts from ACT 44 to ACT 45. In a case where the CPU 101 detects that the camera image does not include the person (YES in ACT 44), the process shifts from ACT 44 to ACT 46.

The CPU 4001 detects that the person included in the camera image is wearing the uniform of the store or that the person included in the camera image is not wearing the uniform (ACT 45). In ACT 45, for example, the CPU 4001 detects that the person included in the camera image is wearing the uniform of the store or that the person included in the camera image is not wearing the uniform in accordance with whether or not the QR code 8001 can be recognized from the clothes of the person included in the camera image.

In a case where the CPU 4001 recognizes the QR code 8001, the CPU 4001 detects that the person included in the camera image is wearing the uniform of the store.

In a case where the CPU 4001 does not recognize the QR code 8001, the CPU 4001 detects that the person included in the camera image is not wearing the uniform of the store. Accordingly, the CPU 4001 detects that the customer is present within the predetermined area by identification of the customer or clerk based on the camera image. Detecting that the customer is present within the predetermined area by identification of the customer or clerk based on the camera image is an example of detecting that the customer is present within the predetermined area on the basis of the camera image.

In a case where the CPU 4001 detects that the person included in the camera image is not wearing the uniform of the store (NO in ACT 45), the process shifts from ACT 45 to ACT 46.

The CPU 4001 sends True as the second message to the mobile settlement terminal 1000 on the basis of detection that the customer is present within the predetermined area on the basis of the camera image (ACT 47).

In a case where the CPU 4001 detects that the person included in the camera image is wearing the uniform of the store (YES in ACT 45), the process shifts from ACT 45 to ACT 4.

The CPU 4001 sets the value of N+1 to the identification number #N of the network camera 3005 (ACT 47). In ACT 46, for example, the CPU 4001 sets the value of N+1 to the identification number #N on the basis of detection that the camera image does not include the person. The CPU 4001 sets the value of N+1 to the identification number #N on the basis of detection that the person included in the camera image is wearing the uniform of the store.

The CPU 4001 determines whether or not N to which the value has been set is greater than 3 (ACT 48). Here, since the system SB includes the three network cameras 3005, the CPU 4001 compares N with 3. Therefore, the CPU 4001 only needs to compare N with the number of network cameras 3005 included in the system SB. In a case where N to which the value has been set is not greater than 3 (NO in ACT 48), the process shifts from ACT 48 to ACT 43. In a case where N to which the value has been set is greater than 3 (YES in ACT 48), the process shifts from ACT 48 to ACT 49.

The CPU 4001 performs the process of ACT 44 with respect to camera images from all the network cameras 3005. Accordingly, the CPU 4001 detects that no customers are present within the predetermined area on the basis of the camera images. The CPU 4001 is capable of performing the process of ACT 45 with respect to the camera image from the network camera 3005. Accordingly, the CPU 4001 is capable of detecting that no customers are present within the predetermined area by identification of the customer or clerk based on the camera image.

The CPU 4001 sends False as the second message to the mobile settlement terminal 1000 on the basis of detection that no customers are present within the predetermined area on the basis of the camera image (ACT 49).

As described above, the CPU 1001 of the mobile settlement terminal 1000 is capable of executing the reboot for updating the control software on the basis of detection that no customers are present within the predetermined area. Accordingly, the CPU 1001 is capable of controlling the timing of the reboot for updating the software.

As described above, the CPU 1001 of the mobile settlement terminal 1000 is capable of detecting that no customers are present within the predetermined area on the basis of a detection result from the IoT gateway 3003. Accordingly, the CPU 1001 is capable of reducing the processing load for detecting that no customers are present within the predetermined area by linking to the IoT gateway 3003.

As described above, the CPU 4001 of the IoT gateway 3003 is capable of detecting that no customers are present within the predetermined area by identification of the customer or clerk. Accordingly, since the CPU 4001 identifies the person present within the predetermined area as the customer or clerk, the CPU 4001 is capable of increasing the accuracy of detection that no customers are present within the predetermined area.

As described above, the CPU 4001 of the IoT gateway 3003 is capable of detecting that no customers are present within the predetermined area on the basis of the camera image. Accordingly, the CPU 4001 is capable of increasing the accuracy of detection that no customers are present within the predetermined area by recognizing a person from the camera image.

It should be noted that in the above description referring to FIG. 21, the example in which the CPU 4001 detects that no customers are present within the predetermined area has been described, though not limited thereto. The CPU 101 may detect that no people are present within the predetermined area without distinguishing customers from clerks. In this example, in the flowchart illustrating FIG. 21, ACT 45 is omitted. Therefore, in a case where the CPU 4001 detects that the camera image includes the person in ACT 44 (NO in ACT 44), the process shifts from ACT 44 to ACT 47. The citation, "no customers are present within the predetermined area," in the above description referring to FIGS. 20 and 21 may be interpreted as "that no people are present within the predetermined area." The citation, "that the customer is present within the predetermined area," in the above description referring to FIGS. 20 and 21 may be interpreted as "that a person is present within the predetermined area."

In this example, the CPU 1001 of the mobile settlement terminal 1000 is capable of executing the reboot for updating the control software on the basis of detection that no people are present within the predetermined area. Accordingly, the CPU 1001 is capable of controlling the timing of the reboot for updating the software.

The CPU 1001 of the mobile settlement terminal 1000 is capable of detecting that no people are present within the predetermined area on the basis of a detection result from the IoT gateway 3003. Accordingly, the CPU 1001 is capable of reducing the processing load for detecting that no people are present within the predetermined area by linking to the IoT gateway 3003.

The CPU 4001 of the IoT gateway 3003 is capable of detecting that no customers are present within the predetermined area on the basis of the camera image. Accordingly, the CPU 4001 is capable of increasing the accuracy of detection that no customers are present within the predetermined area by recognizing a person from the camera image.

### Other Embodiments

In the above-mentioned embodiments, the description has been made using the store as an example of the predetermined area, though not limited thereto. In a case where the control device is outside the store, the predetermined area may be an area different from the store.

In the above-mentioned embodiments, the description has been made using the mobile POS printer 100 or the mobile settlement terminal 1000 as an example of the control device, though not limited thereto. The control device may be a device that is used in a store different from the mobile POS printer 100 or the mobile settlement terminal 1000. The control device only needs to a device capable of executing control on the basis of the control software, and is not limited to the device used in the store. The control device is not limited to the portable device. The control device may be a stationary device.

The above-mentioned embodiments may be applied to a method that is executed by the device. The above-mentioned embodiments may be applied to a program capable of causing a computer of the device to execute each function. The above-mentioned embodiments may be applied to a recording medium that stores the program.

Each of one or more arithmetic circuits that constitutes the processing circuit executes one or more processes of the plurality of processes. In a case where the processing circuit is constituted by a single arithmetic circuit, the single arithmetic circuit executes all the plurality of processes. In a case where the processing circuit is constituted by a plurality of arithmetic circuits, each of the plurality of arithmetic circuits executes some of the plurality of processes. Some of the plurality of processes may be one of the plurality of processes or may be two or more of the plurality of processes. In a case where the processing circuit is constituted by the plurality of arithmetic circuits, the plurality of arithmetic circuits may be included in a single device or may be distributed in a plurality of devices.

The program may be delivered in a state stored in a device according to an embodiment or may be delivered in a state not stored in the device. In the latter case, the program may be delivered via a network or may be delivered in a state recorded on a recording medium. The recording medium is a non-transitory tangible medium. The recording medium is a computer-readable medium. The recording medium can take any form as long as it is a computer-readable medium capable of storing the program, such as a CD-ROM or a memory card.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control device, comprising:
storage configured to store control software for enabling control on an operation in the device to be executed, the control software including an operation control program for controlling the operation of the device and a software update program for updating the control software; and
a processing circuit configured to
execute the control on the operation based on the operation control,
detect, in a case of updating the control software on a basis of the software update program, whether or not no people are present within a predetermined area where the device is installed, and
execute reboot for updating the control software on a basis of detection that no people are present within the predetermined area.

2. The control device according to claim 1, wherein
the device is installed in a store,
that no people are present within the predetermined area is that there are no customers who visit the store within the predetermined area, and
the processing circuit executes the reboot for updating the control software on a basis of detection that no customers are present within the predetermined area.

3. The control device according to claim 2, wherein
the processing circuit detects that no customers are present within the predetermined area by identification of the customer or clerk.

4. The control device according to claim 2, further comprising
a camera that captures an image of the predetermined area, wherein
the processing circuit detects that no customers are present within the predetermined area on a basis of the image captured by the camera.

5. The control device according to claim 4, wherein
the control software further includes a monitor program for scanning a probe request frame of a wireless LAN in the store, and
the processing circuit detects that no customers are present within the predetermined area on a basis of the captured image in a case where there are no probe requests of the wireless LAN in the store as a result of the scan based on the monitor program.

6. A control method for a control device, comprising:
storing, in storage, control software for enabling the control to be executed of an operation (printing) in the control device, the control software including an operation control program for controlling the operation of the device and a software update program for updating the control software;
executing the control on the operation of the control device on a basis of the operation control program;
detecting, in a case of updating the control software on a basis of the software update program, whether or not no people are present within a predetermined area where the device is installed; and
executing the reboot for updating the control software on a basis of detection that no people are present within the predetermined area.

7. A control system, comprising:
a control device that includes
storage configured to store control software for enabling control on the operation in the device to be executed, the control software including an operation control program for controlling the operation of the device and a software update program for updating the control software, and
a processing circuit configured to
execute the control on the operation based on the operation control program,
acquire, in a case of updating the control software on a basis of the software update program, a detection result indicating that no people are present within a predetermined area where the device is installed, and
execute the reboot for updating the control software on a basis of the detection result indicating that no people are present within the predetermined area; and
a communication device that detects that no people are present within the predetermined area and sends a detection result indicating that no people are present within the predetermined area to the control device on a basis of detection that no people are present within the predetermined area.

8. The control system according to claim 7, wherein
the communication device and the control device are installed in a store,
that no people are present within the predetermined area is that there are no customers who visit the store within the predetermined area, and
the processing circuit of the control device executes the reboot for updating the control software on a basis of a detection result indicating that no customers are present within the predetermined area.

9. The control system according to claim 8, wherein
the communication device detects that no customers are present within the predetermined area by identification of the customer or clerk.

10. The control system according to claim 8, wherein
the communication device includes a camera that captures an image of the predetermined area and detects that no customers are present within the predetermined area on a basis of the image captured by the camera.
